(19) United States
(12) Patent Application Publication
(10) Pub. No.: US 2018/0250689 A1
(43) Pub. Date: Sep. 6, 2018

(54) FLUID DIVERTER

(71) Applicant: LDR Global Industries, LLC, Chicago, IL (US)

(72) Inventor: Walter E. Jackson, Homewood, IL (US)

(21) Appl. No.: 15/448,720

(22) Filed: Mar. 3, 2017

(51) Int. Cl. B05B 1/16

(52) U.S. Cl. CPC B05B 1/1663

(57) ABSTRACT

An apparatus for diverting fluids such as in a shower. The apparatus includes a cartridge within a lumen. The lumen has a fluid input, at least two fluid outputs, and a chamber linking the input and outputs. The cartridge comprises at least two sluices, and is constructed and arranged to slide lengthwise through the chamber. By so sliding, the cartridge positions a sluice into the chamber which determines how fluid flows from the fluid input to the fluid outputs.

### FIELD OF TECHNOLOGY

This disclosure relates to a fluid diverter which directs the flow of fluids toward a selected apparatus.

### BACKGROUND OF THE INVENTION

Many fluid flow devices such as showers/shower devices make use of a directed spray of fluid. For various reasons, it is often desirable to alternate the number and type of fluid sprays. This requires the use of diverters to appropriately divert the flow of fluid to the number and type of sprays suitable for a particular use. As a result, there is clear utility in and benefit from novel fluid diverters.

### DESCRIPTION OF THE DRAWINGS

A detailed description of the invention is hereafter described with specific reference being made to the drawings in which:

FIG. 1 illustrates a perspective view of a cartridge used in a diverter.

FIG. 2 illustrates a perspective view of a diverter used to channel fluid flow.

FIG. 3 illustrates a cut-away forward view of a cartridge positioned within a diverter in a first configuration.

FIG. 4 illustrates a cut-away side view of fluid flow of the first configuration.

FIG. 5 illustrates a cut-away forward view of a cartridge positioned within a diverter in a second configuration.

FIG. 6 illustrates a cut-away side view of fluid flow of the second configuration.

FIG. 7 illustrates a cut-away forward view of a cartridge positioned within a diverter in a third configuration.

FIG. 8 illustrates a cut-away side view of fluid flow of the third configuration.

FIG. 9 illustrates an exploded perspective view of a worm device used to move a cartridge.

For the purposes of this disclosure, like reference numerals in the figures shall refer to like features unless otherwise indicated. The drawings are only an exemplification of the principles of the invention and are not intended to limit the invention to the particular embodiments illustrated.

### BRIEF SUMMARY

To satisfy the long-felt but unsolved needs identified above, at least one embodiment is directed toward an apparatus for diverting fluids. The apparatus comprises a cartridge within a lumen. The lumen defines at least one fluid input, a first fluid output, a second fluid output, and a fluid chamber positioned between, and in fluidic communication with, the inputs and outputs. The cartridge comprises at least two sluices, and is constructed and arranged to move laterally, with respect to a longitudinal axis of the fluid chamber, through the fluid chamber and thereby position a single sluice at a time, within the fluid chamber. Two of the sluices have differently-shaped flow paths. In the alternative, the cartridge may be moved laterally such that a portion of more than one sluice may simultaneously occupy the fluid chamber.

The cartridge may have a first sluice laterally adjacent to a second sluice laterally adjacent to a third sluice. At least one of the sluices is constructed and arranged, when in the fluid chamber, to obstruct the flow of fluid from the fluid input to the first fluid output. At least one of the sluices is constructed and arranged, when in the fluid chamber, to obstruct the flow of fluid from the fluid input to the second fluid output. At least one of the sluices is constructed and arranged, when in the fluid chamber, to allow at least some flow of fluid from the fluid input to both the first and second fluid outputs.

The shaped flow path of at least one of the sluices may be constructed and arranged to direct fluid to more than one fluid output with a flux that is either substantially the same for each output or which is different for each output. The apparatus may exclude the ability of the cartridge to move in a rotatable manner relative to the fluid chamber.

The fluid input may be in fluidic communication with a water or plumbing source. At least one of the fluid outputs may be in fluidic communication with a shower head.

The apparatus of may further comprise a worm drive. The worm drive may be constructed and arranged to receive rotational force and convert it into lateral force which laterally displaces the cartridge relative to the fluid chamber. The lumen and cartridge may be within a housing and the lateral displacement of the cartridge may not alter the overall length of the housing. The apparatus may further comprise a handle. The lumen and cartridge may be within the housing. The handle may define a portion of the housing. The lateral displacement of the cartridge may not cause any alteration of the overall length of the housing.

### DETAILED DESCRIPTION OF THE INVENTION

At least one embodiment may be a fluid diverter used to select through which fluid pathway(s) should a fluid flow. In many fluid using arrangements, especially when the fluid is a liquid, is water, and/or when used in a shower, there are two or more possible apparatuses available. A user may wish to alternate between using one, another, or more than one of those apparatuses. For example, many showers today have more than one shower head, and at different times a user may wish to operate either or both shower heads.

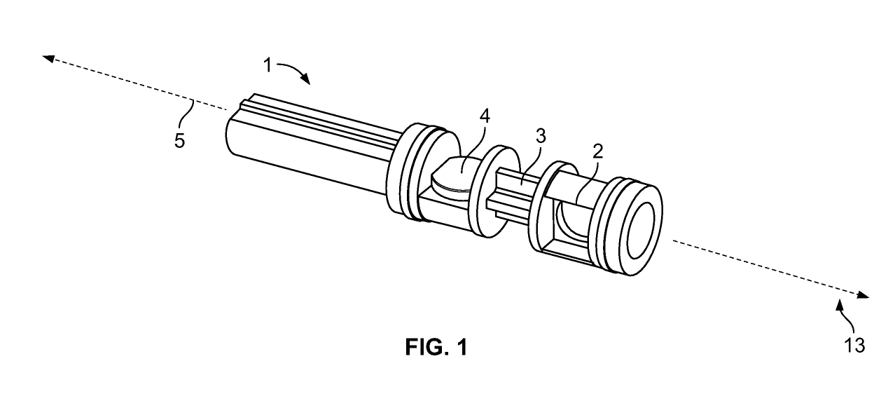

In at least one embodiment the fluid flow path is controlled by use of a cartridge (1). As illustrated in FIG.1, a cartridge (1) has two or more sluices (2, 3, 4). Each of these sluices, when positioned in a flow chamber, either blocks fluid flow, or channels fluid flow into a specific direction, such as into one or more output conduits. In at least one embodiment the cartridge (1) is constructed and arranged to move in a lateral direction (5) relative to a longitudinal axis of the cartridge (1), thereby changing which sluice (2, 3, 4) is positioned within the flow chamber.

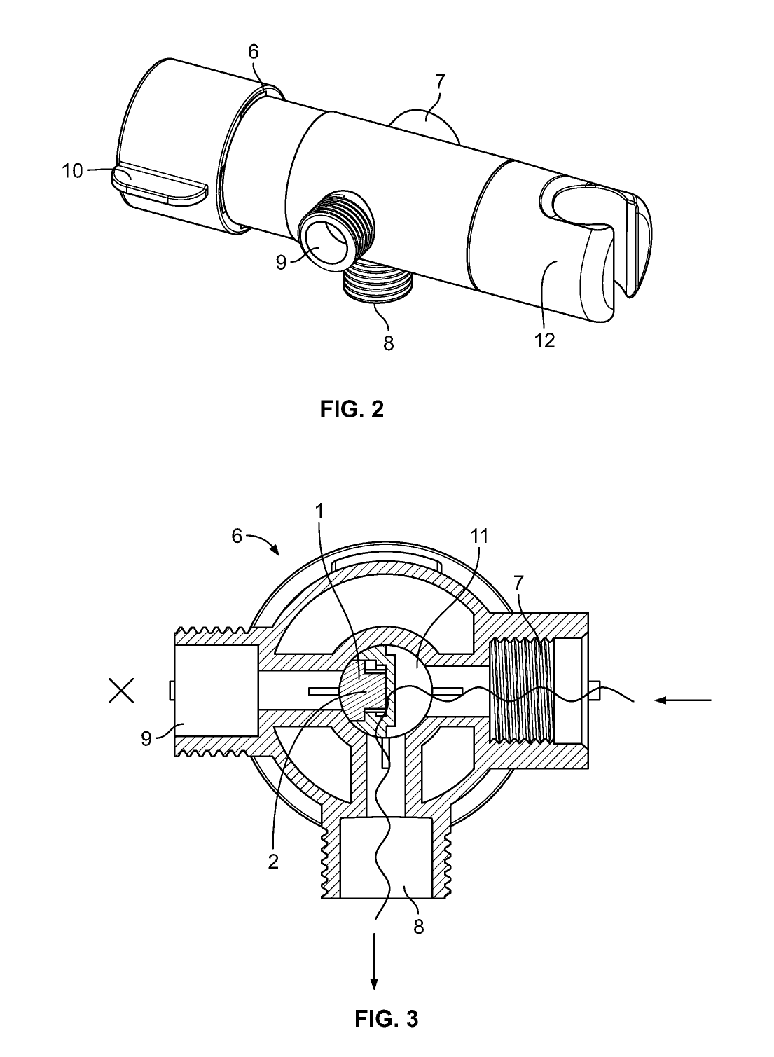

Referring now to FIG. 2 there is shown a diverter (6) within which the cartridge is positioned. Fluid enters the diverter (6) through an input (7) and may pass through a flow chamber into a first output conduit (8) and or a second output conduit (9). In some embodiments, there may be two or more inputs and/or three, four, or more output conduits. The diverter may further include a handle (10). One or more brackets (12) or other gripping/holding device may optionally be present to engage one or more output apparatuses such as a shower head. While some of the figures illustrate, the handle having a rotating cap with wings, the handle may be constructed and arranged according to any manner known in the art. Other contemplated manners of constructing and arranging the handles include but are not limited to loop handles, ring handles, handles bearing finger shaped grips, bar handles, high friction handles, rubber coated handles, rust resistant handles, and any combination thereof.

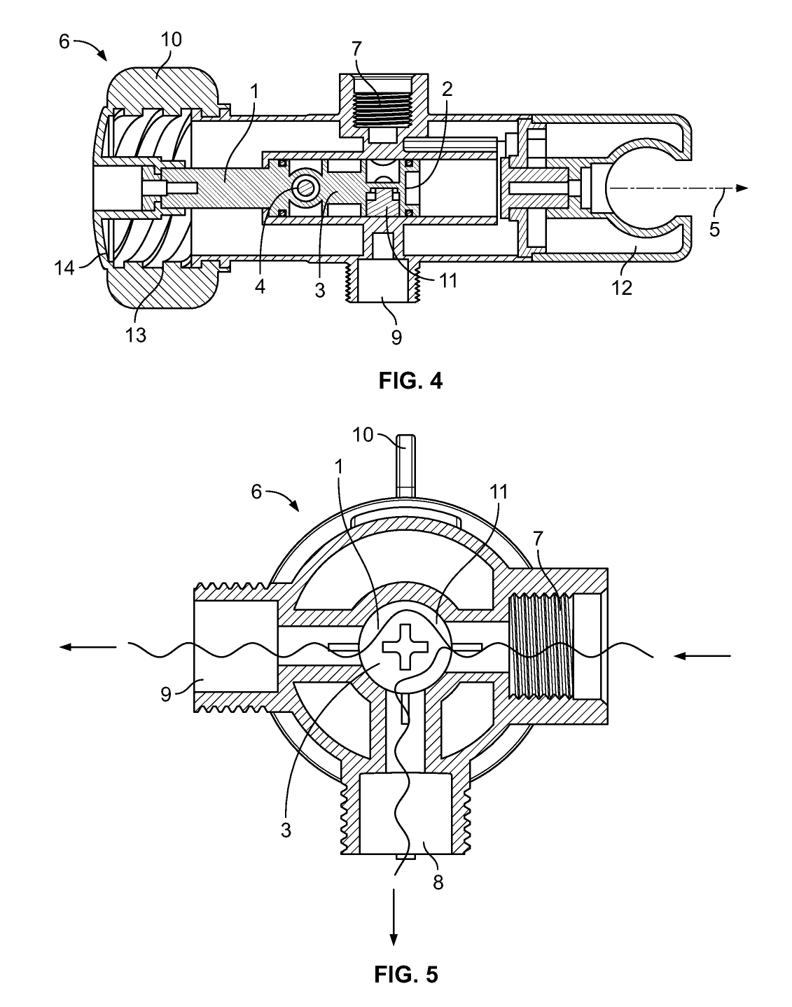

FIGS. 3 and 4 illustrate operation of a diverter (6) when in first configuration. In this configuration, the cartridge (1) is laterally displaced so the first sluice (2) is substantially positioned within the flow chamber (11). The flow chamber (11) is in fluidic communication with the fluid input (7) and the output conduits (8, 9). When in the first configuration, the first sluice (2) orients a barrier between the fluid input (7) and the second output conduit (9). This deflects incoming fluid away from the second output conduit (9) channeling the fluid towards and into the first output conduit (8).

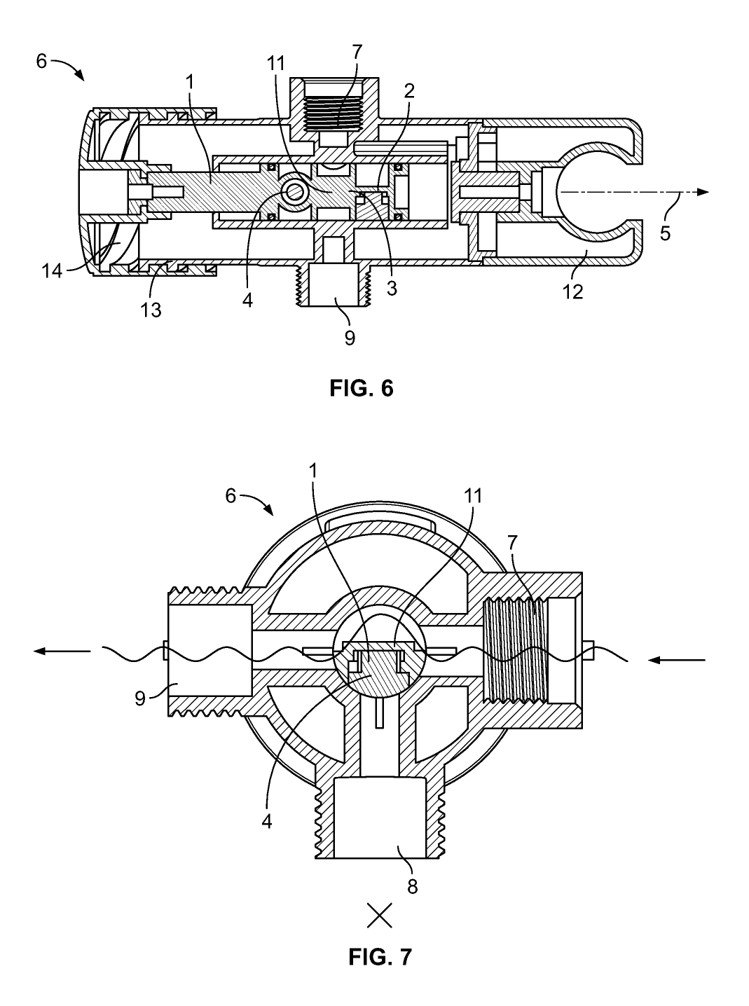

FIGS. 5 and 6 illustrate operation of the diverter (6) when in second configuration. In this configuration, the cartridge (1) has been laterally displaced relative to the first configuration so the second sluice (3) is substantially positioned within the flow chamber (11). The second sluice (3) is a mixed-flow sluice, i.e. it allows for the flow of fluid from the fluid input (7) into more than one fluid output conduit (such as both the first and second output conduits (8, 9)). In at least one embodiment the second configuration (or any other configuration) may apportion fluid flow in an uneven manner facilitating more flow or less flow, to any specific one or more output(s).

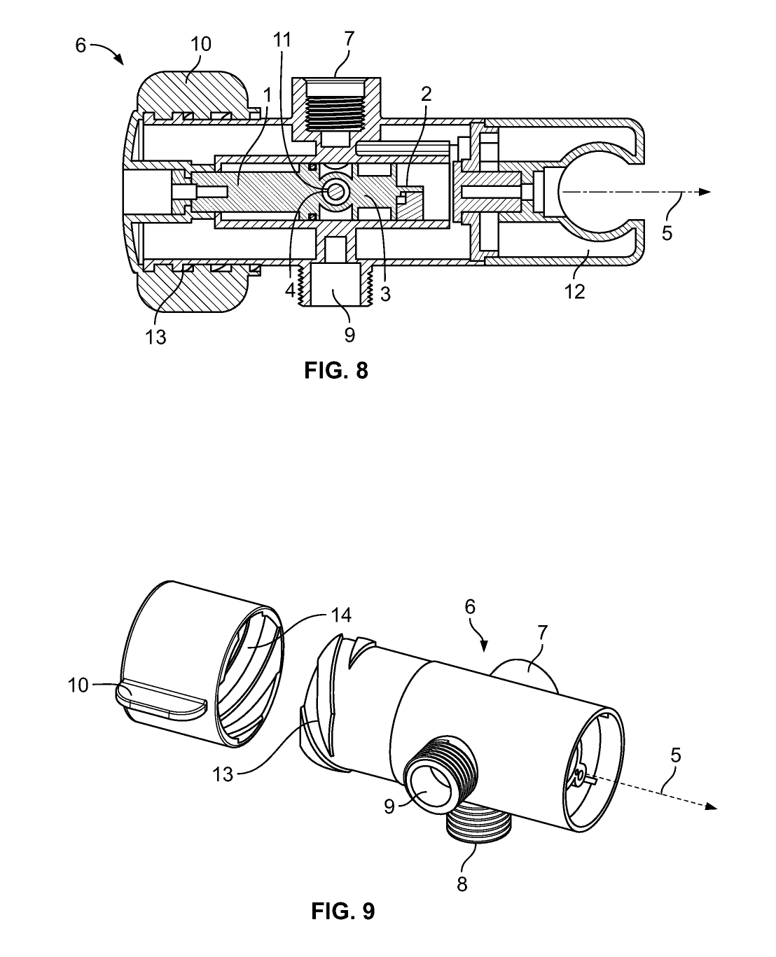

FIGS. 7 and 8 illustrate operation of the diverter (6) when in third configuration. In this configuration, the cartridge (1) has been laterally displaced so the third sluice (4) is substantially positioned within the flow chamber (11). The third sluice (4) orients a barrier between the fluid input (7) and the first output conduit (8). This deflects incoming fluid away from the first output conduit (8) channeling the fluid towards and into the second output conduit (9).

The sluices are not limited to the specific sequence or geometry present in the figures. Instead each of the sluices can define a wide variety of shapes and arrangements and can be ordered in any possible sequence. These shapes and arrangements include but are not limited to one or more of: holes, helixes, walls (with one or more slopes), curves, bends, mesh patterns, eddy-creators, irregularities, tapers, tubes, undulations, and any combination thereof, and may include valves, washers, releases and other plumbing items, and any combination thereof, designed to change, increase, decrease, optimize, and/or randomize fluid flow rate, pressure, aeration, pulse, droplet shape or size, and/or direct or mix the fluid flow(s) in any manner possible. Similarly, for purposes of this application the term “sluice” additionally includes whatever portion of the cartridge is positioned within the fluid chamber at any given moment. Thus, if the cartridge is only partially displaced so two or more sluices are partially within the fluid chamber, in effect this arrangement defines a new effective sluice made up of the two partial sluices therein.

It can be appreciated that the diverter may be arranged according to several possible arrangements. In at least one embodiment, the cartridge (1) travels relative to the fluid chamber (11) laterally (5) along a longitudinal axis. The longitudinal axis is substantially parallel to, and extends along, the length of the cartridge (1). This may be facilitated by engagement to a handle (10), allowing a user to toggle between configurations by moving the handle (10) laterally or otherwise. The engagement may be in the form of direct engagement or levers, pulleys, springs, and all manner known in the art of engaging a handle to mechanically laterally displace an item. Other possible configurations are possible such as positioning the sluices in a non-linear order and toggling them with non-linear displacement of the cartridge.

In at least one embodiment, the handle (10) mechanically displaces the cartridge (1) using rotational force (see below, discussion of FIGS. 4, 6, 8, and 9). This allows for the combination of rotational motion with lateral motion to leverage two different forms of mechanical force each with their own advantages. Lateral movement of the cartridge (1) allows for precise positioning of the sluices in the chamber. However, size constraints or user preferences may prevent respective lateral displacement of the handle (10).

In at least one embodiment, the use of rotational force to laterally toggle the sluices is accomplished using a worm drive. A worm drive is a gear arrangement comprising a worm (a screw shaped gear having a helical groove) which is meshed with a worm gear (a cog shaped or helically shaped gear). In this arrangement, torque on the worm gear pushes against the screw shape of the worm which laterally displaces the worm and anything fixedly engaged thereto. In at least one embodiment the overall length of the diverter does not substantially or essentially change (get longer or shorter along the axis) as the cartridge is toggled between configurations. In at least one embodiment the overall length of the diverter does change but by an amount different than the distance that the cartridge is displaced. In at least one embodiment the overall length of the diverter changes by an amount of: 1%-15%, or more, or less.

In at least one embodiment, illustrated in FIGS. 4, 6, 8, and 9 the diverter (6) comprises a worm drive which laterally displaces the cartridge (1). In at least one embodiment, the handle (10) defines a worm gear (which may be in a form such as helical grooves (14) or another appropriate structure), meshed with a worm structure (13) which is fixedly engaged to the cartridge (1). In such an embodiment, different amounts (intensities or duration) of torque on the handle (10) can laterally move the cartridge (1) into the specific configuration desired by a user.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein or mentioned in said referenced materials, are incorporated by reference in their entirety. Furthermore, the invention encompasses any possible combination of some or all of the various embodiments described herein and/or incorporated herein. In addition, the invention encompasses any possible combination that also specifically excludes any one or some of the various embodiments described herein and/or incorporated herein.

The above disclosure is intended to be illustrative and not exhaustive. This description will suggest, many variations and alternatives to one of ordinary skill in this art. All the alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages, ratios and proportions herein are by weight unless otherwise specified.

Those skilled in the art may recognize other equivalents to the specific embodiment described herein which equivalents are intended to be encompassed by the claims attached hereto.

1. An apparatus for diverting fluids, the apparatus comprising a cartridge within a lumen, the lumen defining a fluid input, a first fluid output, a second fluid output, and a fluid chamber positioned between, and in fluidic communication with, the input and outputs, the cartridge comprising at least two sluices, and being constructed and arranged to move through the fluid chamber and thereby position a single sluice at a time, within the fluid chamber, two of the sluices having differently-shaped flow paths.

2. The apparatus of claim 1 in which the cartridge has a first sluice laterally adjacent to a second sluice laterally adjacent to a third sluice.

3. The apparatus of claim 1 in which at least one of the sluices is constructed and arranged, when in the fluid chamber, to obstruct the flow of fluid from the fluid input to the first fluid output, at least one of the sluices is constructed and arranged, when in the fluid chamber, to obstruct the flow of fluid from the fluid input to the second fluid output, and at least one of the sluices is constructed and arranged, when in the fluid chamber, to allow at least some flow of fluid from the fluid input to both the first and second fluid outputs.

4. The apparatus of claim 1 in which the shaped flow path of at least one of the sluices is constructed and arranged to direct fluid to more than one fluid output with a flux that is either substantially the same for each output or which is different for each output.

5. The apparatus of claim 1 excluding the ability of the cartridge to move in a rotatable manner relative to the fluid chamber.

6. The apparatus of claim 1 in which the fluid input is in fluidic communication with a water source, a plumbing source, a sewage system, and/or a waste-water disposal system.

7. The apparatus of claim 6 in which at least one of the fluid outputs is in fluidic communication with a shower device.

8. The apparatus of claim 7 in which the shower device includes a shower head.

9. The apparatus of claim 1 further comprising a worm drive, the worm drive is constructed and arranged to receive rotational mechanical force and convert it into lateral mechanical force which laterally displaces the cartridge relative to the fluid chamber.

10. The apparatus of claim 1 in which the lumen and cartridge are within a housing and the lateral displacement of the cartridge does not alter the overall length of the housing.

11. The apparatus of claim 1 in which the lumen and cartridge are within a housing and the lateral displacement of the cartridge is different than the alteration of the overall length of the housing.

12. The apparatus of claim 1 further comprising a handle, the lumen and cartridge are within a housing, the handle defines a portion of the housing, and the lateral displacement of the cartridge does not alter the overall length of the housing.

13. The apparatus of claim 1 further comprising a handle, the lumen and cartridge are within a housing, the handle defines a portion of the housing, and the lateral displacement of the cartridge alters the overall length of the housing by a distance different from the amount of cartridge lateral displacement.

14. The apparatus of claim 1 wherein the cartridge is further constructed and arranged to move through the fluid chamber in a lateral direction with respect to a longitudinal axis of the of the fluid chamber.

15. A cartridge, the cartridge including a first sluice, a second sluice and a third sluice, each of the sluices encompassing a flow path, the first sluice encompasses a first wall blocking a portion of the first sluice's flow path and extending along a first angle, the second sluice encompasses a second wall blocking a portion of the second sluice's flow path and extending along a second angle, the second angle differing from the first angle, the third sluice lacks a wall at a respective location where at least a portion of the first or second wall is located in the first or second sluice, the three sluices are positioned sequentially and along an axis.

16. A method of diverting fluid in a lumen, the method comprising the steps of:
passing fluid through a first sluice in a cartridge, the sluice constructed and arranged to direct the fluid towards a first combination of output conduits, and
laterally displacing the cartridge so the fluid no longer passes through the first sluice but instead passes through a second sluice in the cartridge, the second sluice constructed and arranged to direct the fluid towards a second combination of output conduits, the second combination of output conduits differing from the first combination of output conduits,
each combination of output conduits comprising at least one, of two or more output conduits.
